(19) United States
(12) Patent Application Publication
(10) Pub. No.: US 2002/0175249 A1
(43) Pub. Date: Nov. 28, 2002

(54) B stand

(76) Inventor: Brenda Lee Wells, Staten Island, NY (US)

Correspondence Address: MS. BRENDA LEE WELLS, 90 CEBRA AVENUE, STATEN ISLAND, NY, 10304, US

(21) Appl. No.: 09/864,047

(22) Filed: May 24, 2001

(51) Int. Cl. F16M 11/00; A45D 19/04

(52) U.S. Cl. 248/127

(57) ABSTRACT

A SELF-SUPPORTING TABLE, FLOOR STAND AS WELL AS A CLAMP-ON STAND WHICH INCLUDES A SUPPORT BASE (10) WITH A CENTERED THREADED HOLE (12) FOR THE FLOOR AND TABLE MODEL. A SUPPORT BASE (42) WITH A CENTERED THREADED HOLE WITH THREADS FOR THE CLAMP ON MODEL. THE CLAMP ON SUPPORT BASE (42) HAS AN ADJUSTABLE KNOB FOR TIGHTENING. A BOTTOM EXTENSION POLE (14) HAS OUTWARD EXTENSIONS WITH THREADS (18), AND AN INWARD HOLE ON THE TOP (16). THE BOTTOM EXTENSION POLE (14) IS TWISTED INTO THE BOTTOME BASE (10). THE VERSATILE MIDDLE BOTTOM EXTENSION POLE (20), HAS OUTWARD EXTENSION WITH THREADS (22), (24) ON EACH END. THE VERSATILE MIDDLE EXTENSION POLE (20) TWIST INTO THE BASE OF THE TABLE MODEL AND THE CLAMP ON MODEL. THE VERSATILE MIDDLE EXTENSION POLE (20) TWIST INTO THE BOTTOM EXTENSION POLE (14) ON THE FLOOR MODEL. THE TOP EXTENSION POLE (26) HAS AN INWARD HOLE WITH THREADS (28) ON THE BOTTOM, A SOLID SLANTED TOP FINISH ON THE TOP, AND A FATTIE REST STAY AREA (32) NEAR THE BOTTOM. THE TOP EXTENSION POLE (26) IS TWISTED INTO THE VERSATILE MIDDLE EXTENSION POLE (20) ON THE FLOOR, TABLE AND CLAMP ON MODELS. THE SLANTED WEDGE (34) HAS A CENTERED HOLE (36). THE SLANTED WEDGE (34) IS PLACED ON TOP OF THE TOP EXTENSION POLE (26) THROUGH THE SLANTED WEDGE (34) CENTERED HOLE AND COME TO THE STAY AREA (32) OF THE TOP EXTENSION POLE. THE TOP BASE (38) HAS A CENTERED HOLE (40). THE TOP BASE (38) IS PLACED ON TOP OF THE SLANTED WEDGE (38) SANDWICHING THE SLANTED WEDGE BETWEEN THE TOP BASE (38) AND THE FATTIE STAY AREA (32) OF THE TOP EXTENSION POLE (26).

### CROSS-REFERENCE TO RELATED APPLICATIONS

“NOT APPLICABLE”

### STATEMENT REGARDING FEDERALLY SPONSORED RESEARCH OR DEVELOPMENT

“NOT APPLICABLE”

### REFERENCE TO A MICROFICHE APPENDIX

“NOT APPICABLE”

### BACKGROUND OF THE INVENTION

THERE ARE NO SIMILAR OR OTHER RELATED INVENTIONS WITH THE FUNCTION OF THE “B” STAND“. THE “B” STAND WAS INVENTED TO ALLEVIATE CHAOS WHILE EXCESS OR ADDITIONAL HAIR IS BEING ADDED TO ONES NATURAL HAIR WHILE HAVING ONESELF OR OTHERS STYLE AND CREATE HAIRSTYLES. THERE ARE NO PRIOR INVENTIONS FOR THIS PURPOSE.

### BRIEF SUMMARY OF THE INVENTION

THE “B” STAND PRIMARY OBJECTIVE IS TO HOLD, KEEP CONTROL AND KEEP ORGANIZED ALL EXCESS HAIR AT HOME AND IN HAIR SALONS WHILE THE EXCESS HAIR IS ADDED TO ONES NATURAL HAIR. IN REGARD TO HAIR BRAIDING, HAIR WEAVING, OR CREATING HAIR STYLES OR ANY OTHER REASON EXCESS HAIR WOULD NEED TO BE CONTROLED, HELD, OR ORGANIZED.

THE INVENTION IS A SELF-SUPPORTING STAND. THE FLOOR MODEL IS FOR AREAS WITH MAXIMUM FLOOR SPACE. THE TABLE MODEL IS FOR AREAS WITH MAXIMUM SHELF SPACE. THE CLAMP-ON MODEL IS FOR AREAS WITH MINIMUM SHELF OR COUNTER SPACE AND SMALL WORKING AREAS. THE INVENTION IS A PORTABLE LITE-WEIGHT STAND THAT CAN BE MOVED FROM PLACE TO PLACE WITH EASE.

THE INVENTION CAN BE ASSEMBLED AND UNASSEMBLED IN MINUTES.

ANOTHER ADVANTAGE OF THE INVENTION IS THAT THE ASSEMBLY MAY BE ECONOMICALLY MANUFACTURED. THE COMPONENTS INCLUDING THE BASE MAY BE FABRICATED FROM ALL METALS, PLASTICS AS WELL AS WOODS. THIS OPTION HELPS A SALON TO STAY IN ACCORDANCE WITH THE DÉCOR OF THE SHOP. IT ALSO HELPS ONE TO HAVE A CHOICE IN HOME USE.

ANOTHER ADVANTAGE OF THE INVENTION IS THAT IT IS COMPACT TO FIT INTO ANY SPACE FOR STORAGE, IN SALONS AND IN HOME USE.

AN ADVANTAGE OF THE “B” STAND IS THAT IT WILL SOLELY REPLACE THE CONCERNS AND WORRIES OF CLIENTS IN HAIR SALONS AND AT HOME OF WHETHER THE EXCESS HAIR IS BEING KEPT AS CLEAN AS POSSIBLE WHILE THE EXCESS HAIR IS BEING ADDED TO ONES NATURAL HAIR.

DUE TO PAST DISADVANTAGES NO LONGER WILL EXCESS HAIR BE PLACED ON FLOORS, COUNTERTOPS, SALON CHAIRS OR ASKED OF CLIENTS TO HOLD THE EXCESS HAIR WHILE IT IS BEING ADDED TO ONES NATURAL HAIR IN HAIR SALONS. NO LONGER WILL EXCESS HAIR BE PLACED ON BEDS, DRESSERS, CHAIRS, ETC., WHILE AT HOME OR IN PRIVATE USE WHEN ADDING EXCESS HAIR TO ONES NATURAL HAIR.

A FEATURE OF THE INVENTION IS THAT THE SELF-SUPPORTING BASE MAY BE REPLACED OR CHANGED WITH THE CLAMP-ON BASE. THE CLAMP-ON BASE MODEL CAN BE SECURED TO A CHAIR, COUNTER, TABLE OF SHELF OR WITH A WALL MOUNT AND SUPPORTED BY A WALL.

THE INVENTION STOPS CLIENTS FROM WALKING AWAY FROM A HAIR SALON BECAUSE OF THE EXTREME UNSANITARY FLOOR AND SHELF CONDITIONS WHICH OCCUR FROM EXCESS HAIR HAVING NO WHERE TO BE KEPT CLEAN, CONTROLLED OR ORGANIZED.

AN ADVANTAGE IS NO LONGER WILL HAIR SHADES BECOME MIXED UP AND CONFUSED WITH OTHER HAIR SHADES BECAUSE OF NO CONTROL WHEN EXCESS HAIR IS UNPACKED AND USED.

THE INVENTION HAS A SLANTED WEDGE ABLING THE TOP BASE TO SLANT WHEN POSITIONED TO ALLOW ONE THE FACE THE STAND TOWARD THE HAIR STYLIST. THIS FEATURE HELPS THE EXCESS HAIR TO BE PICKED UP AND PLACED BACK AND AROUND THE TOP EXTENSION POLE KEEPING CONTROL OF THE EXCESS HAIR.

THESE AND FURTHER OBJECTS, FEATURES AND ADVANTAGES OF THE INVENTION WILL BECOME APPARENT FROM THE FOLLOWING DETAILED DESCRIPTION, WHEREIN REFERENCES IS MADE TO THE FIQURES IN THE ACCOMPANYING DRAWINGS.

### BRIEF DESCRIPTION OF THE SEVERAL VIEWS OF THE DRAWING

IN THE DRAWINGS CLOSELY RELATED FIGURES HAVE THE DIFFERENT NUMBERS BUT SAME ALPHABETIC SUFFIXES.

FIG. 1A, 1B, 1C, (FRONT VIEWS) OF THE FLOOR, TABLE AND CLAMP-ON MODELS.

FIG. 2A, 2B, (REAR VIEWS) OF THE FLOOR, AND TABLE MODEL.

FIG. 3A, 3B, 1C (SIDE VIEWS) OF THE FLOOR, TABLE, AND CLAMP-ON MODELS.

FIG. 4A, 4B, 2C, (SEPARATED VIEW) OF THE FLOOR TABLE, CLAMP-ON MODELS.

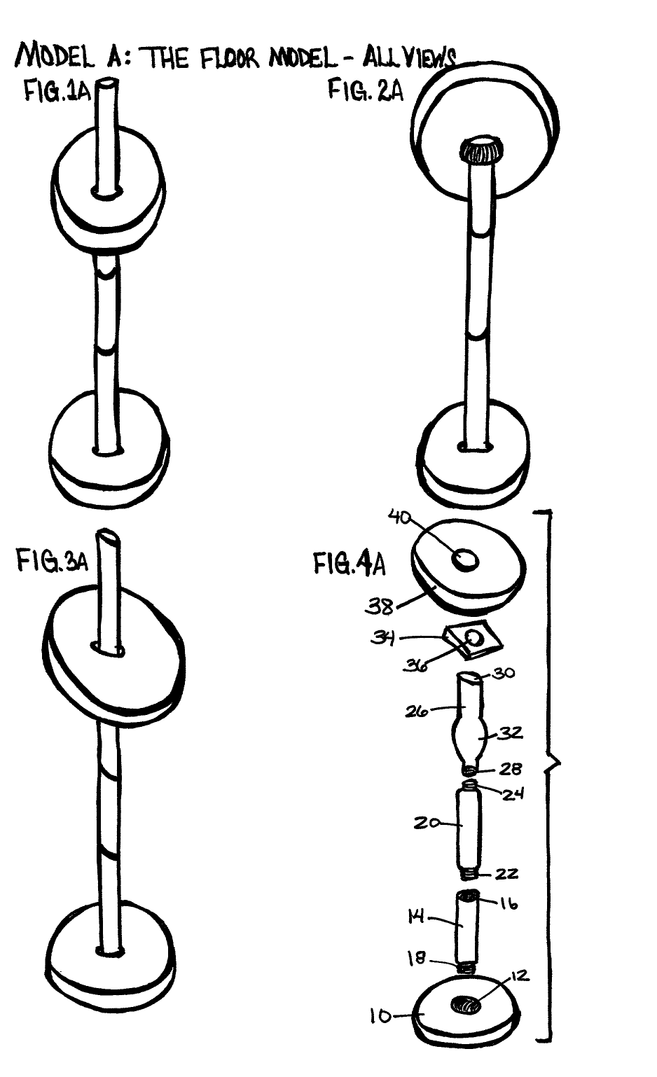

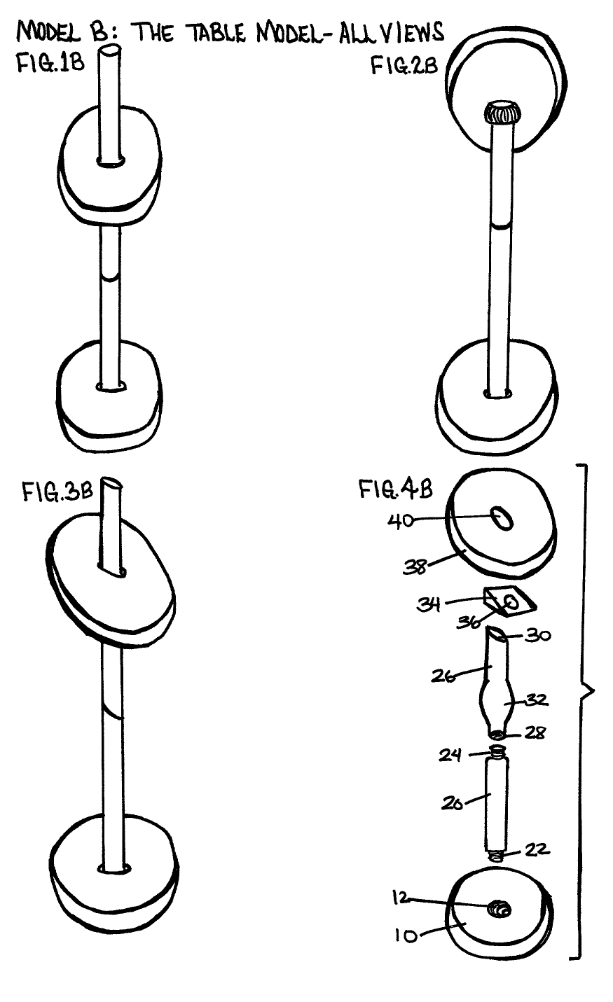

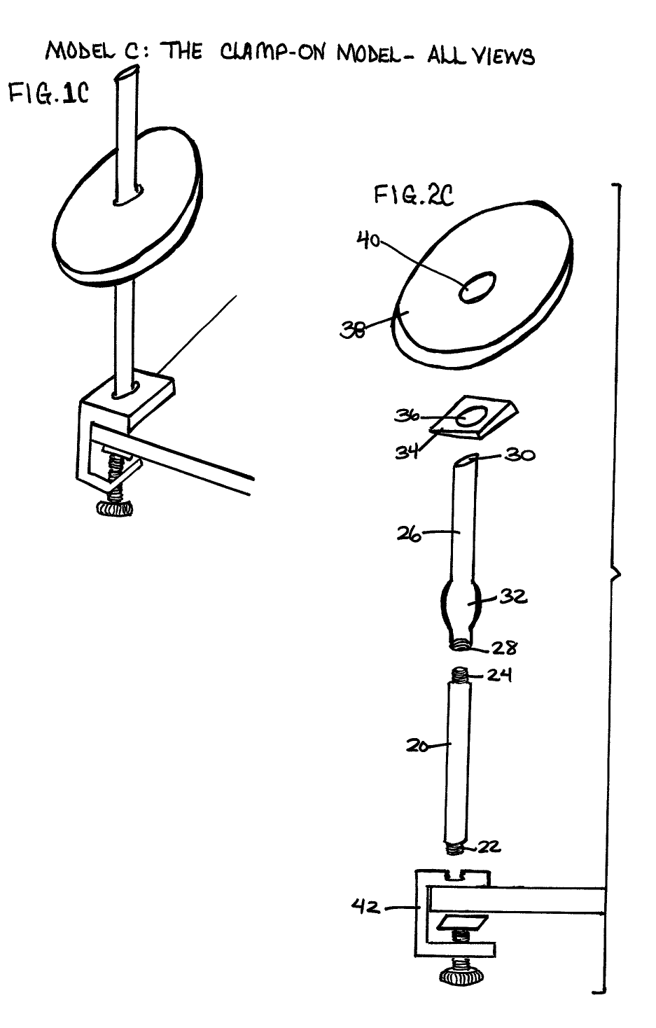

### REFERENCE NUMERALS IN DRAWINGS

10 SUPPORT BASE

12 SUPPORT BASE THREADED HOLE

14 BOTTOM EXTENSION POLE

16 INWARD HOLE WITH THREADS

18 OUTWARD EXTENSION WITH THREADS

20 VERSATILE MID-BOTTOM EXTENSION POLE

22 OUTWARD EXTENSION WITH THREADS

24 OUTWARD EXTENSION WITH THREADS

26 TOP EXTENSION POLE

28 INWARD HOLE WITH THREADS

30 SOLID SLANTED TOP FINISH

32 FATTIE STAY AREA

34 SLANTED WEDGE

36 SLANTED WEDGE CENTERED HOLE

38 TOP BASE

40 TOP BASE CENTERED HOLE

42 LAMP-ON SUPPORT BASE WITH ADJUSTABLE SCREW TIGHTENER

### DETAILED DESCRIPTION OF THE INVENTION

A PREFERRED EMBODIMENT OF THE PRESENT INVENTION A SELF-SUPPORTING ADJUSTABLE STAND AS WELL AS A CLAMP-ON STAND IS COMPRISED A SUPPORT BASE 10 AND A SUPPORT BASE 42 WHICH CAN BE FORMED FROM A RELATIVELY HEAVY MATERIAL WHICH HAS SUFFICIENT WEIGHT TO STABILIZE THE STAND. THE SUPPORT BASE 10 MAY INCORPORATE A NON-SLIP PAD, SMALL RUBBER DISKS, TO PREVENT SLIPPING OR FRICTION AGAINST FLOORS, COUNTER TOPS OR WHEN PLACED ON ANY SURFACE WHILE IN USE. THE SUPPORT BASE 42 MAY INCORPORATE NON-SLIP RUBBER PADS SANDWICHED BETWEEN THE ADJUSTABLE GRIP TO PREVENT SLIPPING OR FRICTION AGAINST COUNTER TOPS OR WHEN MOUNTED AND SECURED BY A WALL.

THE SUPPORT BASE 10 AND SUPPORT BASE 42 FURTHER DEPICTS AN INVERTED THREADED HOLE 12. THE THREADED HOLE 12 IS GEOMETRICALLY CENTERED IN THE SUPPORT BASE 10 AND SUPPORT BASE 42 TO ENHANCE THE STABILITY OF THE ASSEMBLY. THE BOTTOM EXTENSION POLE 14 ON THE FLOOR MODEL A, HAS AN INWARD THREADED HOLE 16 ON ITS TOP AND A OUTWARD THREADED HOLE 18 ON ITS BOTTOM. THE BOTTOM EXTENSION POLE 14 IS THEN TWISTED AND TIGHTENED PERPENDICULAR INTO THE CENTERED THREADED HOLE OF THE BOTTOM SUPPORT BASE 10 OF MODEL A. THE VERSATILE MID-BOTTOM EXTENSION POLE 20 HAS OUTWARD EXTENSIONS WITH THREADS 22 AND 24 AT EACH END. THE VERSATILE MID-BOTTOM EXTENSION POLE 20 IS THEN TWISTED INTO THE BOTTOM EXTENSION POLE 14 ON THE FLOOR MODEL A. THE VERSATILE MID-BOTTOM EXTENSION POLE 20 IS TWISTED AND TIGHTENED INTO THE CENTERED THREADED HOLE OF THE BOTTOM SUPPORT BASE 10 ON THE TABLE MODEL B. THE VERSATILE MID-BOTTOM EXTENSION POLE 20 IS TWISTED AND TIGHTENED INTO THE CENTERED THREADED HOLE OF THE BOTTOM SUPPORT BASE 42 OF THE CLAMP-ON MODEL C.

THE TOP EXTENSION POLE 26 HAS AN INWARD THREADED HOLE 28 AT ITS BOTTOM. THE TOP EXTENSION 26 HAS A SOLID SLANTED TOP FINISH 30 ON ITS TOP. THE TOP EXTENSION POLE 26 HAS A FATTIE STAY AREA 32. THE TOP EXTENSION POLE 26 IS TWISTED AND TIGHTENED INTO

THE VERSATILE MID-BOTTOM EXTENSION POLE 20. THE SLANTED WEDGE 34 HAS A SLANTED CENTERED HOLE 36. THE SLANTED WEDGE 34 IS POSITIONED OVER AND THROUGH THE SLANTED WEDGE CENTER HOLE 36 AND COME TO A REST POSITION ON THE FATTIE STAY AREA 32 OF THE EXTENSION POLE 26.

THE TOP BASE 38 HAS A TOP BASE CENTERED HOLE 40. THE TOP BASE 38 IS PLACED THROUGH THE TOP EXTENSION HOLE 40 AND COME TO A REST ON TOP OF THE SLANTED WEDGE 34 SANDWICHING THE SLANTED WEDGE 34 BETWEEN THE FATTIE STAY AREA 32 OF THE TOP EXTENSION POLE 26 AND THE TOP BASE 38. THE TOP EXTENSION POLE 26 THEN PRUTRUDES THROUGH THE SLANTED WEDGE 34 AND THE TOP BASE 38.

ADDITIONAL EMBODIMENTS ARE ALL EXTENSION POLES 14,20,26, WILL BE OF TUBULAR SHAPE. THE TOP EXTENSION POLE 26 HAS A THICKER SECTION ON THE TUBULAR SHAPE CREATING A REST STAY AREA. THE INVENTION CAN BE ECONOMICALLY MAUNUFATURED IN METAL, HOWEVER, IT WILL ALSO BE AVAILABLE IN WOODS, OR PLASTICS WHEN MANUFACTURED. THE SUPPORT BASE 10 AND THE TOP BASE 40 IS PREFERABLY DISK SHAPED. THE SLANTE WEDGE 34 IS SQUARED IN SHAPE HAVE ON SIDE FINE SHINING THICKER THAN THE OTHER CREATING A SLANT.

ALTHOUGH THE DESCRIPTION ABOVE CONTAIN MANY SPECIFICATIONS, THESE SHOULD NOT BE CONTRUDED AS LIMITING THE SCOPE OF THE INVENTION BUT AS MERELY PROVIDING ILLUSTRATIONS OF SOME OF THE PRESENTLY PREFERRED EMBODIMENTS OF THIS INVENTION. FOR EXAMPLE THE LEAD-IN CONNECTIONING PARTS MAY BE PRESS FIT, OR OTHER CONVENTIONAL SECURING TECHNIQUES OTHER THAN THE DESCRIBED THREADED CONNECTING CLOSURES IN THE PRESENT INVENTION. THE SHAPES, SUCH AS CIRCULAR, OVAL, TRAPEZOIDAL, TRIANGLE, ETC. WILL BE APPRECIATED BY THOSE SKILLED IN THE ART THAT VARIOUS CHANGES IN THE SIZE, SHAPE AND MATERIALS, AS WELL AS IN THE DETAILS OF THE ILLUSTRATED CONSTRUCTION OR COMBINATIONS OF FEATURES OF THE SELF-SUPPORTING ADJUSTABLE STAND AND CLAMP-ON STAND MAY BE MADE WITHOUT DEPARTING FROM THE SPIRIT OF THE INVENTION, WHICH IS DEFINED BY THE claims.

What I claim as my invention is:

1. A FLOOR, TABLE LIKE STAND, AS WELL AS A CLAMP-ON STAND WHICH HOLDS AND CONTROLS EXCESS HAIR THAT IS BEING ADDED TO ONES NATURAL HAIR, COMPRISING;
A SOLID SUPPORT BASE OF SUFFICIENT WEIGHT TO STABILIZE THE FLOOR AND TABLE STAND; ALTERNATIVELY THE CLAMP ON SUPPORT BASE ALSO IS OF SUFFICIENT WEIGHT TO STABILIZE THE CLAMP ON SUPPORT BASE, WITH AN ADJUSTABLE KNOB FOR TIGHTENING THE CLAMP ON MODEL C, A BOTTOM EXTENSION POLE, A VERSATILE MIDDLE EXTENSION POLE, A TOP EXTENSION POLE, A SLANTED WEDGE AND A TOP BASE.

2. BOTH SUPPORT BASE OF claim 1 WHEREIN HAS A CENTERED INWARD HOLE WITH THREADS.

3. THE BOTTOM EXTENSION POLE OF claim 1 WHEREIN HAS AN OUTWARD EXTENSION ON ITS BOTTOM WITH THREADS.

4. THE BOTTOM EXTENSION POLE OF claim 3 OUTWARD THREADS ALLOWS THE BOTTOM EXTENSION POLE TO TWIST INTO THE INWARD HOLE OF THE SUPPORT BASE.

5. THE BOTTOM EXTENSION POLE OF claim 3 HAS AN INWARD HOLE ON TOP WITH THREADS.

6. THE VERSATILE MIDDLE BOTTOM EXTENSION POLE OF claim 1 HAS OUTWARD EXTENSIONS ON EACH END.

7. THE VERSATILE MIDDLE BOTTOM EXTENSION POLE OF claim 6 IS TWISTED INTO THE BOTTOM EXTENSION POLE ON THE FLOOR MODEL A AND THE TABLE MODEL B.

8. THE VERSATILE MIDDLE BOTTOM EXTENSION POLE OF claim 6 IS OPTIONAL FOR HEIGHTENING AND SHORTENING THE FLOOR MODEL A.

8. THE CLAMP ON SUPPORT BASE WITH ADJUSTABLE KNOB TIGHTENER OF claim 1 HAS A CENTERED HOLE WITH THREADS.

9. THE VERSATILE MIDDLE BOTTOM EXTENSION POLE OF claim 6 IS TWISTED INTO THE CLAMP ON SUPPORT BASE WITH ADJUSTABLE KNOB ON THE MODEL C.

10. THE TOP EXTENSION POLE IN claim 1 HAS A BOTTOM INWARD HOLE WITH THREADS.

11. THE TOP EXTENSION POLE IN claim 10 HAS A FATTIE AREA NEAR THE BOTTOM CREATING A STAY POSITION.

12. THE TOP EXTENSION POLE IN claim 10 HAS A SOLID SLANTED TOP FINISH.

13. THE TOP EXTENSION POLE IN claim 10 IS TWISTED INTO THE VERSATILE MIDDLE BOTTOM EXTENSION POLE.

14. THE SLANTED WEDGE IN claim 1 HAS A CENTERED HOLE.

15. THE SLANTED WEDGE IN claim 14 IS THICK ON ONE END AND THIN ON THE OTHER END, THIS FEATURE CREATES A SLANT.

16. THE SLANTED WEDGE IN claim 14 IS PLACED OVER THE TOP EXTENSION POLE THROUGH THE CENTERED HOLE.

17. THE TOP BASE IN claim 1 HAS A CENTERED HOLE.

18. THE TOP BASE IN claim 17 IS PLACED OVER THE SLANTED WEDGE SANDWICHING THE SLANTED WEDGE BETWEEN THE FATTIE AREA OF THE TOP EXTENSION POLE AND THE TOP BASE.
